(19) United States
(12) Patent Application Publication
(10) Pub. No.: US 2008/0150759 A1
(43) Pub. Date: Jun. 26, 2008

(54) RFID reader enabled Intelligent Traffic Signalling and RFID enabled Vehicle tags(Number Plates)

(76) Inventor: Sridhara Subbiah Ramasubbu, (US)

Correspondence Address: Sridhara S Ramasubbu, 6512 Limerick ct, Clarksville, MD, 21029, US

(21) Appl. No.: 11/558,178

(22) Filed: Nov. 9, 2006

(51) Int. Cl. G08G 1/08; G08G 1/01

(52) U.S. Cl. 340/922; 340/941

(57) ABSTRACT

This invention pertains to the use of RFID (Radio Frequency ID) technology in Vehicle's Number plates that can be issued by the Motor vehicle administration of the respective state governments. This RFID's will be communicating with the Intelligent Traffic signaling system to efficiently handle traffic.

The same RFID's can also be used to store the owners information along with critical medical information like blood group, primary physician's name and contact. This life saving information can be used to help the Police and Paramedics to save the life in trouble with no delay.

The active radio frequency signals transmitted from the above RFID's can be used to switch the traffic signals ON/OFF to get the life in trouble to hospital on time.

### BACKGROUND OF THE INVENTION

1. Field of the Invention

This invention relates to traffic control systems and, more particularly, to an Intelligent system that switches the traffic signal utilizing the unused time slice. This is achieved by installing smart RFID readers along with the intelligent processor which read the number plates of the vehicles stopped in the signal to calculate the signaling time more efficiently.

Tracking the vehicles in the absence of GPS and Cell Phones—Nobody can drive vehicles without tags (Number Plates)

Deadly traffic violations like “Running red Light” can be controlled by recording the violated vehicles and can be ticketed

RFID readers fitted to the Law enforcement vehicles can easily get the information about the vehicles in trouble even in the absence of wireless connection and satellite communication

2. Description of the Related Art

Automobiles are a part of everyday life in urban and suburban communities. Traffic lights dot the landscape in urban centers and the surrounding communities, and control the flow of traffic on roads, large and small. Drivers must pay attention to traffic signals and failure to heed them results in increased traffic congestion and accidents.

While traffic controls are a necessary part of any road and highway system, measures are taken to try to keep the traffic flow on the major arteries moving as much as possible.

This can be achieved by utilizing the unused time slice. The “Unused” time slice happens when there is very few vehicles given larger time slice to pass by. At this moment this unused time slice can be awarded to most demanding direction based on this invention. This invention always ensures the safety of the vehicles by giving enough time for the on coming vehicles to stop at the time of switching.

The priority index is the code or numbering assigned to each RFID fitted to the number plate by the Motor Vehicles Administration or Department of Motor Vehicles which can be read by the RFID reader installed in the traffic signal to judge the importance of the vehicles waiting for the signals.

Any additional information stored in this RFID's fitted to the number plates by MVA or DMV can also be used to track the vehicle movement with out GPS or cell phone tracking system.

This invention is completely different from the conventional traffic signal and any other traffic related smart systems in the following ways:
1. This is different from the conventional traffic signal, which checks the lane only at the time of switching, not after the switching
2. It is also different, that the unused time is allocated to the most wanted direction, not to the next signal in sequence
3. The RFID readers are installed in every direction of the traffic signal
4. The intelligent processor is installed locally to the traffic signal, which can also interact with the other traffic signal processors
5. Priority of the number plates fitted to the vehicles can be analyzed by this local processors to give right of way to the emergency vehicles like Ambulance and Law enforcement vehicles
6. The vehicles will not receive any data from the intelligent processor
7. The traffic signal can not be influenced by any other source except the count and the priority index of the vehicles
8. The data processed by the processor will not be broadcasted to any external systems

### SUMMARY OF THE INVENTION

In accordance with the present invention, Radio Frequency ID readers installed in the traffic signal read the number plates of the vehicles stopped in the signal and will be processed by the Intelligent processor to switch the signals more efficiently and effectively.

The Priority Index and other information assigned to each RFID fitted to the number plate by the Motor Vehicles Administration or Department of Motor Vehicles can be used to override the signal or to track the vehicles with out GPS or Cell phone.

### BRIEF DESCRIPTION OF THE DRAWINGS

FIG. 1 illustrates the general architecture of the present invention;

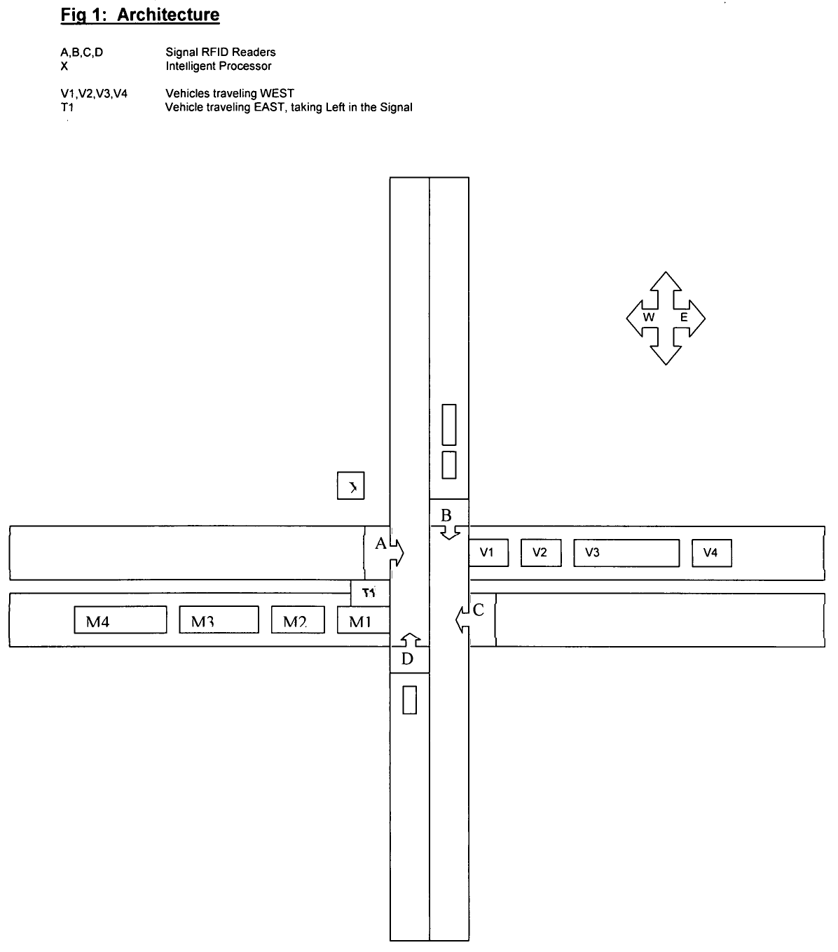

FIG. 2 is a flowchart illustrating the Algorithm of the switching system

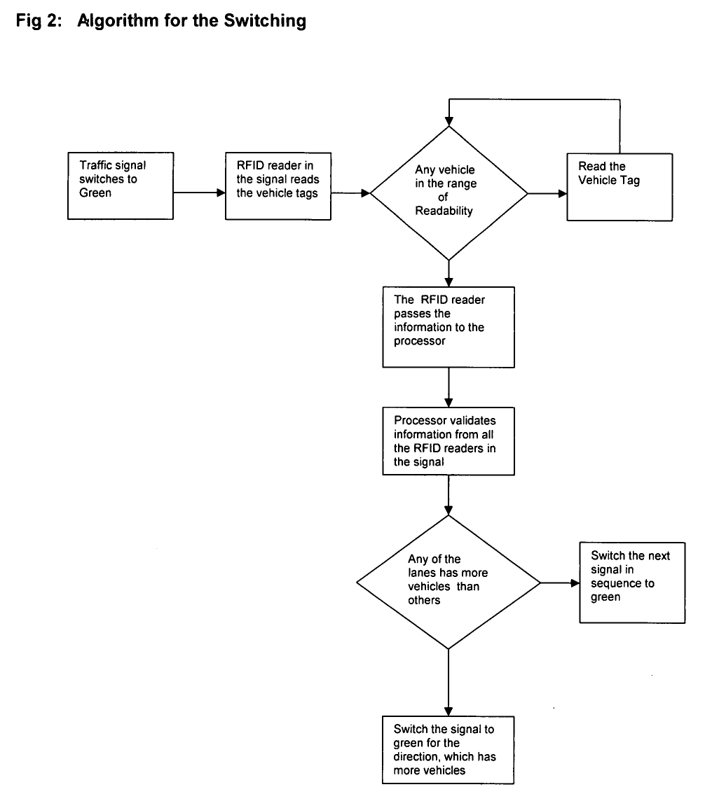

### PROCESS: SCENARIO WITH OUT THE INVENTION

1. Signal C allocates 30 Sec for the Vehicle T1 to take left
2. 25 Sec. reminds unused after the vehicle T1 passed
3. Signal B and D switches to Green to let the vehicles to pass

### PROCESS: SCENARIO WITH THE INVENTION

1. Signal C allocates 30 Sec for the Vehicle T1 to take left
2. RFID reader in signal C, finds no vehicles in the middle lane
3. RFID reader in Signal A, which is in next sequence reads and calculates the vehicles V1-V4
4. The Intelligent Processor X is provided with the information from the reader installed in signal C and A
5. The Processor decides to utilize the unused 25 Sec, and switch the signals A and C to “Green” to let vehicles V1-V4 and M1-M4 to pass, since the traffic is more in that direction.
6. Signal B and D gets their regular allocated time
7. This extra switching will reduce the traffic congestion in that signal
8. This is different from the conventional traffic signal, which checks the middle lane only at the time of switching, not after the switching
9. It is also different, that the unused time is allocated to the most wanted direction, not to the next signal in sequence.

We claim:

1. A method by which the traffic is regulated more efficiently by utilizing the unused signal time in any traffic signal. An electronic device fitted in the traffic signal will read and analyze the data from the special RFID (Radio Frequency ID) enabled “Number Plates” and switches the signal utilizing the unused signal time.
The intelligent electronic device in the traffic signal will cut short the time slice, if it finds there is no vehicles to utilize the time slice; switching will happen immediately to utilize this unused time slice. This method of switching will allocate more time for high traffic and less time for the low traffic directions. No need for any clock based signal pattern change.
Based on the type and the count of these RFID's the traffic signals will alter its switching time to clear up traffic and maintain clear and smooth traffic flow.

2. A method by which the vehicles are tracked by the traffic signals using RFID enabled tags.

3. A method by which the deadly traffic violations like “Running red Light” can be controlled by recording the violated vehicles and can be ticketed

4. A method by which RFID readers fitted to the Law enforcement vehicles can easily get the information about the vehicles even in the absence of satellite communication and wireless technology.

5. The method of claim 1, wherein said the intelligent processor realizes that there is no vehicles to utilizes the time slice

6. The method of claim 2, wherein the processor calculates the demand for the under utilized time.

7. The method of claim 3, wherein the intelligent processor allocates the unused time to the high traffic direction.

8. The method of claim 1, wherein said traffic signal processor communicates with the tag's (Number Plates) RFID.

9. The method of claim 1, wherein said traffic signal processor counts and analyses the tag RFID's including the priority data

10. A system comprising: Each direction of traffic signal has a separate transponder to read vehicle's RFID's which will feed the data to the intelligent processor. The processor will analyze the data and switches the system locally.

11. An algorithm can be defined for the switching mechanism with in the same traffic signal or can be synchronized with the other traffic signals. This algorithm evaluate the count and the priority level of the tags (Number Plates) to justify the switching needs.
